(19) United States
(12) Patent Application Publication
(10) Pub. No.: US 2019/0303674 A1
(43) Pub. Date: Oct. 3, 2019

(54) System for assisting cognitive faculty, an assist appliance, a cellular phone, and a server

(71) Applicant: Masahide Tanaka, Osaka (JP)

(72) Inventor: Masahide Tanaka, Osaka (JP)

(73) Assignee: NL Giken Incorporated, Osaka (JP)

(21) Appl. No.: 16/370,998

(22) Filed: Mar. 31, 2019

(30) Foreign Application Priority Data
Mar. 31, 2018 (JP) 2018-070485
Mar. 31, 2018 (JP) 2018-070488
Mar. 31, 2018 (JP) 2018-070497

(51) Int. Cl. G06K 9/00; H04M 1/725; G06F 3/16; G10L 17/06; G10L 17/00; H04R 5/033

(52) U.S. Cl. CPC G06K 9/00671; H04M 1/7253; G06K 9/00255; G06F 3/16; G06K 2209/01; G10L 17/06; G10L 17/005; H04R 5/033; G06K 9/00268

(57) ABSTRACT

A cognitive faculty assisting system comprises a user terminal such as a cellular phone, or an assist appliance, or a combination thereof, and a server in communication with the user terminal. The user terminal acquires the name of a person and an identification data of the person for storage as a reference on an opportunity of the first meeting with the person, and acquires the identification data of the person on an opportunity of meeting again to inform the name of the person with visual and/or audio display if the identification data is in consistency with the stored reference. The reference is transmitted to a server which allows another person to receive the reference on the condition that the same person has given a self-introduction both to a user of the user terminal and the another person to keep privacy of the same person against unknown persons.

A system for assisting cognitive faculty, an assist appliance, a cellular phone, and a server

### BACKGROUND OF THE INVENTION

### 1. Field of the Invention

This invention relates to a system for personal identification, especially to a system for assisting cognitive faculty of an elderly person or a demented patient, assist appliance, a cellular phone, and a personal identification server. This invention also relates to a system including a cellular phone and a server cooperating therewith.

### 2. Description of the Related Art

In the field of personal identification or personal authentication, various attempts have been done. For example, Japanese Publication No. 2010-061265 proposes spectacles including a visual line sensor, a face detection camera, and a projector for overlapping an information image on an image observed through the lens for display, in which face detection is operated in the image photographed by the face detection camera, and when it is detected that the face has been gazed from the visual line detection result, the pertinent records are retrieved by a sever device by using the face image. According to the proposed spectacles, when there does not exist any pertinent record, new records are created from the face image and attribute information decided from it and stored, and when there exist pertinent records, person information to be displayed is extracted from the pertinent records, and displayed by the projector.

On the other hand, Japanese Publication No. 2016-136299 proposes a voiceprint authentication to implement a voice change of the voice uttered by the user according to a randomly selected voice change logic, to transmit a voice subjected to the voice change from user terminal to the authentication server so that the authentication server implements the voice change of a registered voice of the user according to the same voice change logic and implements voiceprint authentication with cross reference to a post-voice changed voice from the user terminal.

However, there still exist in this field of art many demands for improvements of a system for assisting cognitive faculty, assist appliance, a cellular phone, a personal identification server, and a system including a cellular phone and a server cooperating therewith.

### SUMMARY OF THE INVENTION

Preferred embodiment of this invention provides a cognitive faculty assisting system comprising a mobile user terminal and a server.

In detail, the mobile user terminal includes a terminal memory of names of persons and identification data for identifying the persons corresponding to the names as reference data; a first acquisition unit of the name of a person for storage in the memory, wherein the first acquisition unit acquires the name of the person on an opportunity of the first meeting with the person; a second acquisition unit of identification date of the person for storage in the memory, wherein the first acquisition unit acquires the identification data of the person as the reference data on the opportunity of the first meeting with the person, and acquires the identification data of the person on an opportunity of meeting again with the person; an assisting controller that compares the reference data with the identification data of the person acquired by the second acquisition unit on the opportunity of meeting again with the person to identify the name of the person if the comparison results in consistency; a display of the name of the person identified by the assisting controller in case a user of the mobile user terminal hardly reminds the name of the person on the opportunity of meeting again with the person; and a terminal communicator that transmits the identification data of the person corresponding to the name of the person as reference data, and receives for storage the identification data of the person corresponding to the name of the person as reference data which has been acquired by another mobile user terminal.

On the other hand the server includes a server memory of identification data of persons corresponding to the names as reference data; and a server communicator that receives the identification data of the person corresponding to the name of the person as reference data from the mobile user terminal for storage, and transmit the identification data of the person corresponding to the name of the person as reference data to another mobile user terminal for sharing the identification data of the same person corresponding to the name of the same person between the mobile user terminals for the purpose of increasing accuracy and efficiency of the personal identification.

According to a detailed feature of the preferred embodiment of this invention, the first acquisition unit includes an acquisition unit of voice print of a person, and in more detail, the first acquisition unit includes a microphone to pick up real voice of the person including the voice print, or a phone function on which voice of the person including the voice print is received.

According to another detailed feature of the preferred embodiment of this invention, the first acquisition unit includes an acquisition unit of face features of a person, and in more detail, the acquisition unit of face features of the person a camera to capture a real face of the person including face features of the person, or a video phone function on which image of face of the person including the face features is received.

According to still another detailed feature of the preferred embodiment of this invention, the second acquisition unit includes an optical character reader to read characters of the name of a person, or an extraction unit to extract name information from a voice of a person as the linguistic information.

According to another detailed feature of the preferred embodiment of this invention, the display includes a visual display and/or an audio display. In more detail, the mobile user terminal further includes a microphone to pick up a voice of the person, and wherein the audio display audibly outputs the name of the person during a blank period of conversation when the voice of the person is not picked up by the microphone. Or, the audio display includes a stereo earphone, and wherein the audio display audibly outputs the name of the person only from one of a pair of channels of stereo earphone.

Further, according to another detailed feature of the preferred embodiment of this invention, the mobile user terminal includes a cellular phone, or an assist appliance, or a combination of a cellular phone and assist appliance. An example of the assist appliance is a hearing aid, or spectacle having visual display.

Still further, according to another detailed feature of the preferred embodiment of this invention, the server further including a reference data controller that allows the server communicator to transmit the identification data of the person corresponding to the name of the same person as reference data, which has been received from a first user terminal, to a second user terminal on the condition that the same person has given a self-introduction both to a user of the first user terminal and a user of the second user terminal to keep privacy of the same person against unknown persons. In more detail, the reference data controller is configured to allow the server communicator to transmit the identification data of the person corresponding to the name of the same person as a personal identification code without disclosing the real name of the person.

Other features, elements, arrangements, steps, characteristics and advantages according to this invention will be readily understood from the detailed description of the preferred embodiment in conjunction with the accompanying drawings.

The above description should not be deemed to limit the scope of this invention, which should be properly determined on the basis of the attached claims.

### BRIEF DESCRIPTION OF THE DRAWINGS

FIG. 1 is a block diagram of an embodiment of the present invention, in which a total system for assisting cognitive faculty of an elderly person or a demented patient is shown, the system including assist appliance of cognitive faculty, cellular phone, and personal identification server.

FIG. 2 is a table showing data structure and data sample of reference voice print data, reference face data and reference OCR data which are stored in voice print database, face database and OCR database of personal identification server, respectively.

### DETAILED DESCRIPTION OF THE PREFERRED EMBODIMENTS

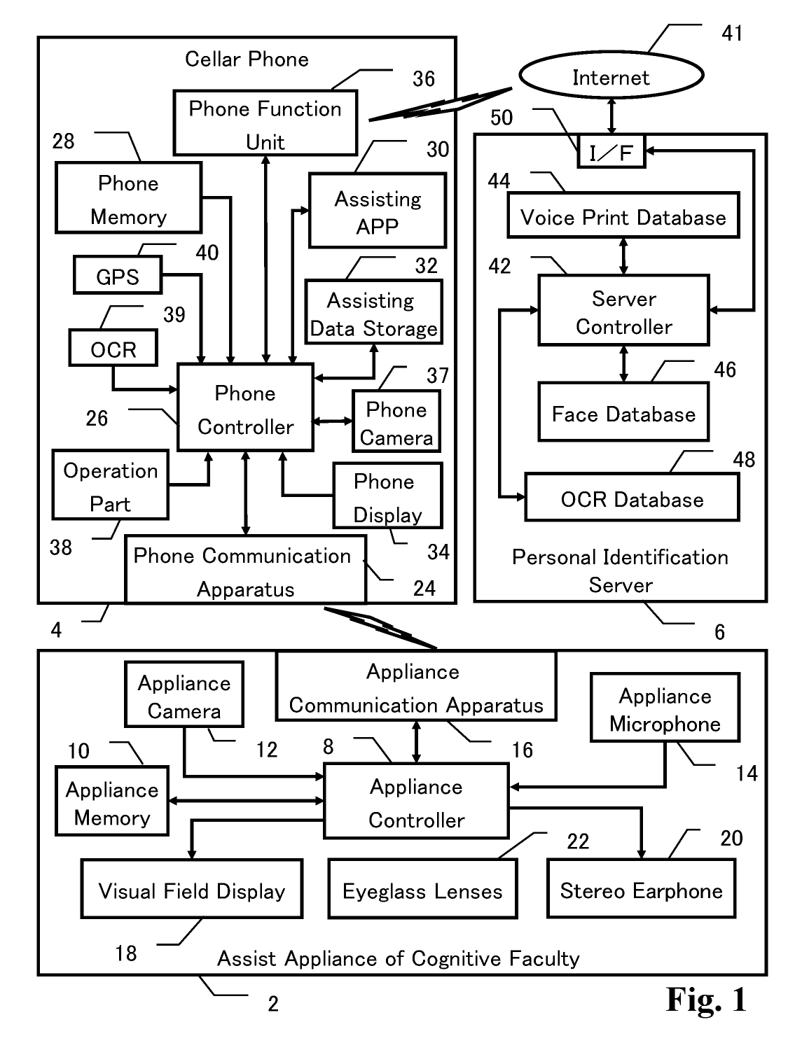

FIG. 1 represents a block diagram of an embodiment of the present invention, in which a total system for assisting cognitive faculty of an elderly person or a demented patient is shown. The system includes assist appliance 2 of cognitive faculty incorporated in spectacles with hearing aid, cellular phone 4 formed as a so-called “smartphone”, and personal identification server 6, in which assist appliance 2 and cellular phone 4 function in combination as a mobile user terminal. Assist appliance 2 includes appliance controller 8 for controlling the entire assist appliance 2, and appliance memory 10 for storing appliance main program for functioning appliance controller 8 and for storing various data such as facial image data from appliance camera 12 and voice data from appliance microphone 14. Appliance controller 8 controls visual field display 18 for displaying visual image in the visual field of a user wearing assist appliance 2, the visual image being based on visual data received through appliance communication apparatus 16 capable of wireless short range communication. Appliance controller 8 further controls stereo earphone 20 for generating stereo sound in accordance with stereo audio data received through appliance communication apparatus 16.

Assist appliance 2 basically functions as an ordinary spectacles with a pair of eyeglass lenses 22, wherein visual field display 18 presents visual image in the real visual field viewed through eyeglass lenses 22 so that the visual image overlaps the real visual field. Assist appliance 2 also functions as an ordinary hearing aid which picks up surrounding sound such as voice of a conversation partner by means of appliance microphone 14, amplifies the picked up audio signal, and generates sound from stereo earphone 20 so that the use may hear the surrounding sound even if the user has poor hearing.

Assist appliance 2 further displays character representation such as a name of a conversation partner in the real visual field so that the character representation overlaps the real visual field, the character representation being a result of personal identification on the basis of facial image data gotten by appliance camera 12. For this purpose, appliance camera 12 is so arranged in assist appliance 2 to naturally cover the face of the conversation partner with its imaging area when the front side of the head of the user wearing the assist appliance 2 is oriented toward the conversation partner. Further, according to assist appliance 2, voice information of the name of a conversation partner is generated from one of the pair of channels of stereo earphone 20 as a result of personal identification on the basis of voice print analyzed on the basis of voice of the conversation partner gotten by appliance microphone 14. The result of personal identification on the basis of facial image data and the result of personal identification on the basis of voice print are cross-checked whether or not both the results identify the same person. If not, one of the results of higher probability is adopted as the final personal identification by means of a presumption algorithm in cognitive faculty assisting application program stored in application storage 30 explained later. Thus, a demented patient who cannot recall a name of an appearing acquaintance is assisted. Not only demented persons, but also elderly persons ordinarily feel difficulty in recalling a name of an appearing acquaintance. Assist appliance 2 according to the present invention widely assists the user as in the manner explained above to remove inferiority complex and keep sound sociability.

For the purpose of achieving the above mentioned cognitive assisting faculty, assist appliance 2 cooperates with cellular phone 4 and personal identification server 6. The facial image data and the voice data are read out form appliance memory 10 which stores the facial image data from appliance camera 12 and the voice data from appliance microphone 14. The data read out form appliance memory 10 are sent to phone communication apparatus 24 capable of wireless short range communication from appliance communication apparatus 16. In appliance communication apparatus 16 and phone communication apparatus 24, one of various wireless short range communication systems is applicable, such as wireless LAN (Local Area Network) or infrared communication system. Phone controller 26 has phone memory 28 store the received facial image data and the voice data. The data stored in phone memory 28 are to be compared with reference data stored in cognitive assisting data storage 32 to identify the conversation partner by means of phone controller 26 functioning in accordance with a processing program in cognitive faculty assisting application program stored in application storage 30 (hereinafter referred to as “assisting APP 30”). The data of the identification, such as name, of conversation partner is transmitted from phone communication apparatus 24 to communication apparatus 16. The transmitted identification data is displayed by visual field display 18 and audibly outputted from one of the pair of channels of stereo earphone 20 as explained above. The identification data such as name, of conversation partner is also displayed on phone display 34.

Phone controller 26, which functions in accordance with the phone main program stored in phone memory 28, is primarily for controlling entire cellular phone 4 including phone function unit 36 in ordinary manner, in addition to the control of the above mentioned cognitive assisting function. Manual operation part 38 and phone display 34, which are also primarily for operation and display relating to phone function unit 36, are utilized for the above mentioned cognitive assisting function. Further, phone camera 37 and phone microphone (not shown) within phone function unit 36, which in combination allow the video phone function, are also utilized for assisting cognitive faculty as will be explained later.

Cellular phone 4 further includes, primarily for controlling ordinary functions of entire cellular phone 4, global positioning system 40 (hereinafter referred to as “GPS 40”). According to the present invention, GPS 40 in combination with the function of phone controller 26 running on the processing program in assisting APP 30 is utilized for assisting cognitive faculty of the user by means of teaching the actual location of the user or directing the coming home route or a route to a visiting home or the like.

Optical character reader 39 (hereinafter referred to as “OCR 39”) of cellular phone 4 is to read a name from an image of a business card received from a conversation partner to convert into text data. The text data gotten by OCR 39 is to be stored into cognitive assisting data storage 32 so as to be tied up with the personal identification on the basis of the facial image data and the voice print. For this purpose, appliance camera 12 is so arranged to capture the image of the name on the business card which comes into the field of view of appliance camera 12 when the head of the user wearing assist appliance 2 faces the business card received from the conversation partner. And, appliance memory 10 once store the captured image of the business card, which is to be read out to be transmitted from appliance communication apparatus 16 to phone communication apparatus 24.

Cellular phone 4 is capable of communicate with personal identification server 6 by means of phone function unit 36 through Internet 41. On the other hand, identification server 6, which includes server controller 42, voice print database 44, face database 46, OCR database 48 and input/output interface 50, communicates with a great number of other cellular phones and a great number of other assist appliances of cognitive faculty. Identification server 6, thus, collects and accumulates voice print data, face data and OCR data of the same person gotten on various opportunities of communicating with various cellular phones and various assist appliances. The voice print data, face data and OCR data are collected and accumulated under high privacy protection. And, the accumulated voice print data, face data and OCR data are shared by the users of identification server 6 under high privacy protection for the purpose of improving accuracy of reference data for personal identification. The data structure of the voice print data, face data and OCR data as reference data stored in cognitive assisting data storage 32, on the other hand, are identical with those of reference data in voice print database 44, face database 46, OCR database 48 of identification server 6. However, among all the reference data in voice print database 44, face database 46, OCR database 48 of identification server 6 gotten by and uploaded from other cellular phones and other assist appliances, only reference data of a person who has given a self-introduction to the user of cellular phone 4 are permitted to be downloaded from identification server 6 to cognitive assisting data storage 32 of cellular phone 4. In other words, if reference data of a conversation partner gotten by assist appliance 2 is uploaded from assisting data storage 32 of cellular phone 4 to identification server 6, the uploaded reference data will be permitted by the identification server 6 to be downloaded by another cellular phone of a second user on the condition that the same conversation partner has given a self-introduction also to the second user. Identification server 6 will be described later in more detail.

Assisting APP 30 and cognitive assisting data storage 32 of cellular phone 4 function not only in combination with appliance camera 12 and appliance microphone 14 of assist appliance 2, but also in combination with phone camera 37 and phone function unit 36 of cellular phone 4. In other words, phone function unit 36 receives voice of intended party during phone conversation, the received voice including voice print information of the intended party. Thus, assisting APP 30 and cognitive assisting data storage 32 carries out the personal identification on the basis of voice print information in the voice received by phone function unit 36 for assisting cognitive faculty of the user. Further, phone camera 37 captures own face of the user on an opportunity such as video phone conversation, the face data of the captured face of the user being provided to identification server 6 as reference data for other persons to identify the user.

Next, the way of getting reference data for personal identification will be explained. As to face data, appliance camera 12 captures the face of a conversation partner on an opportunity of the first meeting when the front side of the head of the user is oriented toward the conversation partner. Image data of the captured face as well as face features extracted from the image data are stored in cognitive assisting data storage 32 by way of appliance memory 10, appliance communication apparatus 16, and phone communication apparatus 24. On the same opportunity of the first meeting with the conversation partner, appliance microphone 14 gets voice of the conversation partner. Voice data of the gotten voice as well as voice print extracted from the voice data are stored in cognitive assisting data storage 32 by way of appliance memory 10, appliance communication apparatus 16, and phone communication apparatus 24.

To determine whose face features and whose voice print had gotten according to the above mentioned manner, the voice of self-introduction from the first met conversation partner is firstly utilized. Further, if a business card is handed to the user from the first met conversation partner, the character information on the business card is utilized. In the case of utilizing voice, assisting APP 30 extracts the self-introduction part as the linguistic information supposedly existing in the voice data corresponding to the opening of conversation stored in cognitive assisting data storage 32, and narrows down the extraction to the name part of the conversation partner as the linguistic information. Thus extracted name part recognized as the linguistic information is related to the face features and the voice print to be stored in cognitive assisting data storage 32. In other words, the voice data is utilized as a dual-use information, e.g., the reference voice print data for personal identification and the name data as the linguistic information related to each other. Not only a chase that appliance microphone 14 of assist appliance 2 is utilized to get voice of the conversation partner in front of the user as explained above, but also such a case is possible that the voice of the intended party far away received through function unit 36 during phone conversation is utilized.

Further, if a business card is handed to the user from the first met conversation partner, appliance camera 12 captures the image of the business card when the head of the user faces the business card as explained above. And, OCR 39 of cellular phone 4 reads a name from an image of a business card to convert the captured name into text data. Thus converted text data as linguistic information is related to the face features and the voice print to be stored in cognitive assisting data storage 32. The conversion of the image of business card into the text data by OCR 39 as explained above is useful in such a case that a self-introduction is made only by showing a business card with redundant reading thereof omitted.

On the other hand, if a self-introduction is made by showing a business card with announcement of the name accompanied, both the name data on linguistic information of the voice and the name data on text data from the business card read by OCR 39 of cellular phone 4 are cross-checked with each other. And, if one of the name data contradict the other, one of the name data of higher probability is adopted as the final name data by means of a presumption algorithm of assisting APP 30. In detail, text data from the business card is to be preferred unless the business card is blurred and illegible.

Next, the function in the case of meeting again is to be explained. Occasionally, a conversation partner may not give her/his name in the case of meeting again. In such a case, the user may hardly remind the name of the meeting again conversation partner. And, if such a memory loss is repeatedly experienced, the user may have a lapse of confidence, which may cause a social withdrawal. Similarly in the case of phone conversation, if the user may hardly remind the name of intended party in spite of clearly recognizing her/his voice and face and such experience may be repeatedly experienced, the user may avoid receiving a call in the first place. For assisting demented persons or elderly person to keep sound sociability, appliance microphone 14 of assist appliance 2 gets voice of the meeting again conversation partner to transmit the gotten voice data to phone controller 26 by means of communication between appliance communication apparatus 16 and phone communication apparatus 24. The voice print data in the transmitted voice data is compared with reverence voice print data stored in cognitive assisting data storage 32 by means of the function of phone controller 26 running on the processing program in assisting APP 30. And, if the transmitted voice print data coincides with one of reverence voice print data, name data related to the coincided reference voice print data is transmitted from phone communication apparatus 24 to appliance communication apparatus 16. The transmitted name data is displayed by visual field display 18 and audibly outputted from one of the pair of channels of stereo earphone 20.

Similar assistance in the case of meeting again is made also with respect to face data. Appliance camera 12 of assist appliance 2 captures the face of a conversation partner on an opportunity of the meeting again when the front side of the head of the user is oriented toward the meeting again conversation partner. The captured image data of the face is transmitted to phone controller 26 by means of communication between appliance communication apparatus 16 and phone communication apparatus 24. And, as has been explained, the face features in the transmitted face image is compared with reverence face features stored in cognitive assisting data storage 32 by means of the function of phone controller 26 running on the processing program in assisting APP 30. And, if the face features of the transmitted face image coincides with one of reverence face features, name data related to the coincided reference face features is transmitted from phone communication apparatus 24 to appliance communication apparatus 16. The transmitted name data is displayed by visual field display 18 and audibly outputted from one of the pair of channels of stereo earphone 20. Further, as has been explained, the personal identification on the basis of voice print data and the personal identification on the basis of face features are cross-checked whether or not both the results identify the same person. If not, one of the results of higher probability is adopted as the final personal identification by means of a presumption algorithm in cognitive faculty assisting application program stored in application storage 30.

In visually displaying the transmitted name by means of visual field display 18 for assisting cognitive faculty in the above explained manner, the name is recommended to be displayed at lower part of the visual field close to the margin thereof so as not to interrupt the visual field although the displayed name may identifiably overlap the real visual field without intermingling therewith since the name is displayed in the real visual field viewed through the pair of eyeglass lenses 22. On the contrary, in audibly informing of the transmitted name by means of stereo earphone 20, the audibly informed name may overlap the real voice from the conversation partner to intermingle therewith, which may result in that both the audibly informed name and the real voice from the conversation partner are hard to hear. To avoid such a situation, the name is audibly outputted only from one of the pair of channels of stereo earphone 20, which makes it easy to differentiate the audibly informed name from the real voice from the conversation partner coming into both the pair of ears of the user. Alternatively, in the case that assist appliance also functions as a hearing aid, the name is audibly outputted from one of the pair of channels of stereo earphone 20 and the amplified voice of the conversation partner is audibly outputted from the other of the pair of channels of stereo earphone 20. Further, in place of audibly outputting the name from one of the pair of channels of stereo earphone 20, the name can be started to audibly output from both the pair of channels of stereo earphone 20 during a blank period of conversation by detecting a beginning of pause of voice from the conversation partner. Or, both the output of audibly informed name from only one of the pair of channels of stereo earphone 20 and the output of audibly informed name during a blank period of conversation by detecting a beginning of pause of voice from the conversation partner can be adopted in parallel for the purpose differentiating the audibly informed name from the voice from the conversation partner.

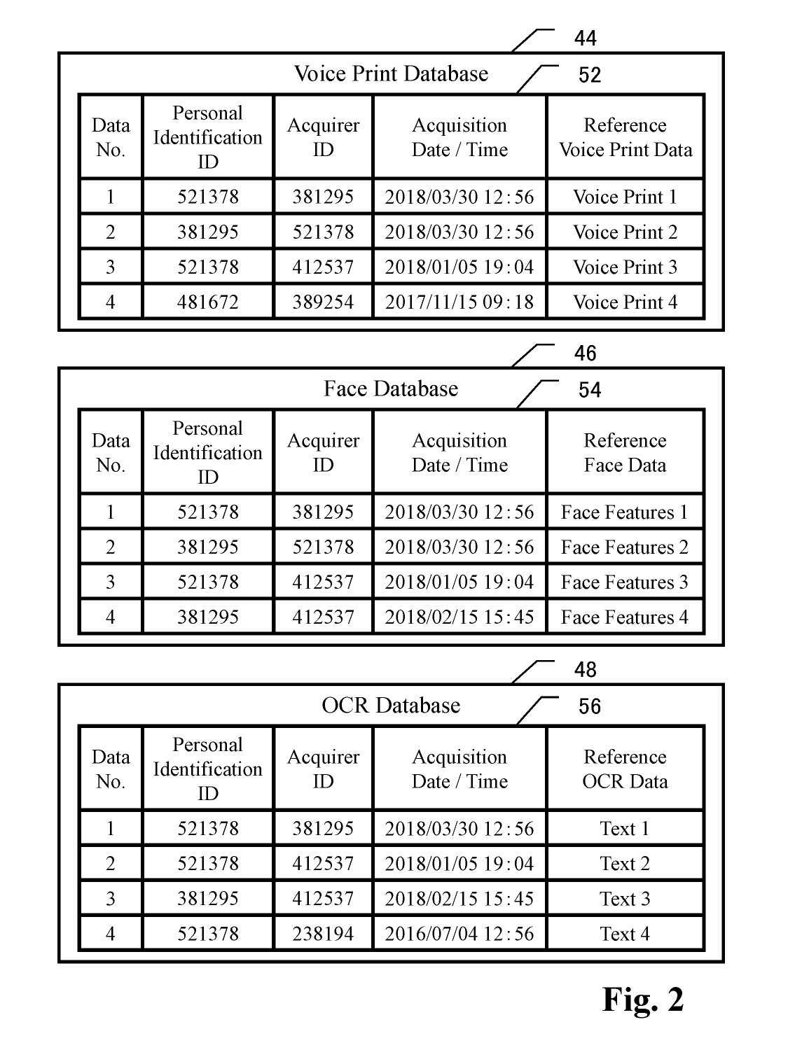

FIG. 2 represents a table showing data structure and data sample of reference voice print data 52, reference face data 54 and reference OCR data 56 which are stored in voice print database 44, face database 46 and OCR database 48 of personal identification server 6, respectively. Server controller 42 shown in FIG. 1 carries out data control according to the data of the above mentioned data structure in cooperation with a great number of cellular phones, the details of the data control being explained later. The respective data structure of reference data shown in FIG. 2 consists, in the case of reference voice print data 52 for example, “data No.”, “personal identification ID”, “acquirer ID”, “acquisition date/time”, and “reference voice print data”. For example, the “data No.1” corresponds to “voice print 1” for identifying a person to whom “521378” is assigned as “personal identification ID”. Although the real name of the person corresponding to “personal identification ID” is registered in identification server 6, such a real name is not open to the public. Further, “521378” as “personal identification ID” in reference voice print data 52 is assigned to a person whose name is recognized as the linguistic information extracted from a voice of self-introduction also used to extract “voice print 1”. Thus, concern about false recognition of the pronounced name still remains in “data No.1” by itself.

Further, reference voice print data 52 in voice print database 44 shows that “data No.1” is acquired at “12:56” on “March 30, 2018” as “acquisition date/time” by a person assigned with “3812952” as “acquirer ID”, and uploaded by him/her to identification server 6, for example. Thus, if a voice print actually gotten from a conversation partner in front of the user is compared with and coincides with “voice print 1” of “data No.1” in voice print database 44, the conversation partner in front of the user is successfully identified as a person to whom “521378” is assigned as “personal identification ID”.

The data of reference voice print data 52 is allowed to be downloaded from identification server 6 into cognitive assisting data storage 32 of cellular phone 4 held by a user as own reference data on condition that the reference voice print data is of a person who has made a self-introduction to the user even if the reverence voice print data has been acquired by others. In other words, cognitive assisting data storage 32 stores number of reference voice print data which are not only acquired by own assist appliance 2 and own cellular phone 4, but also are downloaded from identification server 6 on condition explained above. Such reference voice print data in cognitive assisting data storage 32 will be thus updated day by day.

In detail, “data No.3” in reference voice print data 52 is acquired by another person assigned with “412537” as “acquirer ID”, who has been given a self-introduction by the person assigned with “521378” as “acquirer ID”, and independently uploaded by him/her to identification server 6, for example. In other words, the person assigned with “521378” as “acquirer ID” has given a self-introduction both to the person assigned with “381295” as “acquirer ID” according to “data No.1” and to the person assigned with “412537” as “acquirer ID” according to “data No.3”. This means that the person assigned with “521378” as “acquirer ID” has not any objection to such a situation that her/his name related with her/his voice print data is disclosed to both the person assigned with “381295” as “acquirer ID” and to the person assigned with “412537” as “acquirer ID” among whom “voice print 1” and “voice print 3” are shared. Accordingly, “data No.1” and “data No.3” are downloaded for sharing thereof both to the cognitive assisting data storage of the assist appliance owned by the person assigned with “381295” as “acquirer ID” and to the cognitive assisting data storage of the assist appliance owned by the person assigned with “412537” as “acquirer ID”. Thus, reference voice print data of the same person gotten by specific different persons taking different opportunities are shared by specific different persons on the condition that the same person has given a self-introduction both to the specific different persons. The shared reference voice pint data are cross-checked upon the personal identification to increase accuracy and efficiency of the personal identification on the voice print. However, since the data sharing is carried out on the identification (ID) as an identification code without disclosing to the public the real name of the person assigned with the ID as described above, such privacy that a first person who is acquainted with a second person is also acquainted with a third person is prevented from leaking through the data sharing.

The data structure of reference face data 54 is identical with that of reference voice print data 52 except that the contents of reference face data 54 is “face features 1” etc. whereas the contents of reference voice print data 52 is “voice print 1” etc. Further, “personal identification ID” in reference voice print data 54 is assigned to a person whose name is recognized as the linguistic information extracted from a voice of self-introduction as in the case of the reference voice print data 52. Thus, concern about false recognition of the pronounced name still remains in “personal identification ID” of the reference face data 54 by itself.

With respect to the data sample in FIG. 2 relating to reference voice print data 52 and reference face data 54, “personal identification ID” and “acquirer ID” in “data No. 1” switch positions with those in “data No.2” in both reference voice print data 52 and reference face data 54, in contrast to that “acquisition date/time” is the same in all of “data No. 1” and “data No.2” of reference voice print data 52 and reference face data 54. This means that all the above mentioned data have been uploaded to personal identification server 6 based on the same opportunity of the meeting between the person assigned with “521378” as “personal identification ID” and the person assigned with “381295” as “personal identification ID”. Further, the data sample in FIG. 2 above show that all of the face features, the voice print and the name as the linguistic information extracted from the voice are successfully gotten from both the persons on the same opportunity.

With respect to the data sample in FIG. 2, on the other hand, no reference face features data corresponding to “voce print 4” of voice print data 52 is uploaded into reference face data 54. The reason is presumed that “voce print 4” has been gotten through phone conversation without face features information. Similarly, no reference voice print data corresponding to “face features 4” of reference face data 54 is uploaded into voice print data 52. The reason in this case is presumed that “face features 4” has been gotten through a meeting with a deaf person without voice or the like. In the case of such a “face features 4”, “personal identification ID” related thereto in “data No. 4” is presumed to be determined by means of a cross-check with data in reference OCR data 56 (gotten not only by reading a business card, but also by reading a message exchanged in writing conversation) explained later. Or, “personal identification ID” in “data No. 4” of reference face data 54 is presumed to be manually inputted by means of manual operation part 38 of cellular phone 4.

The data structure of reference OCR data 56 is identical with that of reference voice print data 52 and reference face data 54 except that the contents of reference OCR data 56 is “text 1” etc. whereas the contents of reference voice print data 52, for example, is “voice print 1” etc. Such a difference should be noted, however, that “personal identification ID” in reference OCR data 56 is of a higher reliability than those in reference voice print data 52 and reference face data 54 in that “personal identification ID” in reference OCR data 56 is based on direct reading of name, except for a rare case of miss-reading caused by a blurred character or an illegible character. By the way, reference OCR data 56 does not include any data corresponding to “data No.2” in reference voice print data 52 and reference face data 54 in contrast to that reference OCR data 56 includes “data No.1” corresponding to “data No.1” in reference voice print data 52 and reference face data 54 which have been gotten in the same opportunity. This suggests that no business card has been provided from the person assigned with “381295” as “personal identification ID” to the person assigned with “521378” as “personal identification ID”. On the other hand, according to “data No.3” uploaded into reference OCR data 56, the person assigned with “381295” as “personal identification ID” is assumed to provide a business card to another person assigned with “412537” as “personal identification ID”. And it is clear from reference voice print data 52 and reference face data 54 as discussed above that the person assigned with “381295” as “personal identification ID” has already given a self-introduction to the person assigned with “521378” as “personal identification ID”. This means that the person assigned with “381295” as “acquirer ID” has not any objection to such a situation that “data No.3” including her/his real name is disclosed to the person assigned with “521378” as “personal identification ID”. Accordingly, “data No.3” reference OCR data 56 is downloaded to the cognitive assisting data storage of the assist appliance owned by the person assigned with “521378” as “acquirer ID”. Thus, the reference OCR data of a specific person gotten by limited different persons taking different opportunities is shared by the limiter different persons on the condition that the specific person has given a self-introduction to the limited different persons. The OCR data is sheared and cross-checked with another shared reference OCR data if any upon the personal identification to increase accuracy and efficiency in cognitive faculty assistance.

The functions and the advantages of the present invention explained above are not limited to the embodiments described above, but are widely applicable to other various embodiments. In other words, the embodiment according to the present invention shows the system including assist appliance 2 of cognitive faculty incorporated in spectacles with hearing aid, cellular phone 4, and personal identification server 6. However, the assist appliance of cognitive faculty can be embodied as other appliance which is not incorporated in spectacles with hearing aid. Further, all the functions and the advantages of the present invention can be embodied by a cellular as the mobile user terminal with the assist appliance omitted. In this case, the image of a business card necessary for optical character reader 39 is captured by phone camera 37 within cellular phone 4. And, the cognitive faculty assisting application program such as assisting APP 30 according to the present invention is prepared as one of various cellular phone APP's to be selectively downloaded from a server. In other way around, the function of cellular phone 4 may be incorporated into assist appliance 2.

What is claimed is:

1. A cognitive faculty assisting system comprising:
a mobile user terminal including:
a terminal memory of names of persons and identification data for identifying the persons corresponding to the names as reference data;
a first acquisition unit of the name of a person for storage in the memory, wherein the first acquisition unit acquires the name of the person on an opportunity of the first meeting with the person;
a second acquisition unit of identification date of the person for storage in the memory, wherein the first acquisition unit acquires the identification data of the person as the reference data on the opportunity of the first meeting with the person, and acquires the identification data of the person on an opportunity of meeting again with the person;
an assisting controller that compares the reference data with the identification data of the person acquired by the second acquisition unit on the opportunity of meeting again with the person to identify the name of the person if the comparison results in consistency;
a display of the name of the person identified by the assisting controller in case a user of the mobile user terminal hardly reminds the name of the person on the opportunity of meeting again with the person; and
a terminal communicator that transmits the identification data of the person corresponding to the name of the person as reference data, and receives for storage the identification data of the person corresponding to the name of the person as reference data which has been acquired by another mobile user terminal, and
a server including:
a server memory of identification data of persons corresponding to the names as reference data; and
a server communicator that receives the identification data of the person corresponding to the name of the person as reference data from the mobile user terminal for storage, and transmit the identification data of the person corresponding to the name of the person as reference data to another mobile user terminal for sharing the identification data of the same person corresponding to the name of the same person between the mobile user terminals for the purpose of increasing accuracy and efficiency of the personal identification.

2. The cognitive faculty assisting system according to claim 1, wherein the first acquisition unit includes an acquisition unit of voice print of a person.

3. The cognitive faculty assisting system according to claim 2, wherein the first acquisition unit includes a microphone to pick up real voice of the person including the voice print.

4. The cognitive faculty assisting system according to claim 2, wherein the first acquisition unit includes a phone function on which voice of the person including the voice print is received.

5. The cognitive faculty assisting system according to claim 1, wherein the first acquisition unit includes an acquisition unit of face features of a person.

6. The cognitive faculty assisting system according to claim 5, wherein the acquisition unit of face features of the person a camera to capture a real face of the person including face features of the person

7. The cognitive faculty assisting system according to claim 5, wherein the first acquisition unit includes a video phone function on which image of face of the person including the face features is received.

8. The cognitive faculty assisting system according to claim 1, wherein the second acquisition unit includes an optical character reader to read characters of the name of a person.

9. The cognitive faculty assisting system according to claim 1, wherein the second acquisition unit includes an extraction unit to extract name information from a voice of a person as the linguistic information.

10. The cognitive faculty assisting system according to claim 1, wherein the display includes a visual display.

11. The cognitive faculty assisting system according to claim 1, wherein the display includes an audio display.

12. The cognitive faculty assisting system according to claim 11, wherein the mobile user terminal further includes a microphone to pick up a voice of the person, and wherein the audio display audibly outputs the name of the person during a blank period of conversation when the voice of the person is not picked up by the microphone.

13. The cognitive faculty assisting system according to claim 11, wherein the audio display includes a stereo earphone, and wherein the audio display audibly outputs the name of the person only from one of a pair of channels of stereo earphone.

14. The cognitive faculty assisting system according to claim 1, wherein the mobile user terminal includes a cellular phone.

15. The cognitive faculty assisting system according to claim 1, wherein the mobile user terminal includes an assist appliance.

16. The cognitive faculty assisting system according to claim 15, wherein the assist appliance includes at least one of a hearing aid and spectacle having visual display.

17. The cognitive faculty assisting system according to claim 15, wherein the assist appliance includes a combination of a cellular phone and at least one of a hearing aid and spectacle having visual display.

18. The cognitive faculty assisting system according to claim 1, wherein the server further including a reference data controller that allows the server communicator to transmit the identification data of the person corresponding to the name of the same person as reference data, which has been received from a first user terminal, to a second user terminal on the condition that the same person has given a self-introduction both to a user of the first user terminal and a user of the second user terminal to keep privacy of the same person against unknown persons.

19. The cognitive faculty assisting system according to claim 18, wherein the reference data controller is configured to allow the server communicator to transmit the identification data of the person corresponding to the name of the same person as a personal identification code without disclosing the real name of the person.

20. A server for a cognitive faculty assisting system comprising:
a memory of identification data of persons corresponding to the names as reference data;
a communicator that receives the identification data of the person corresponding to the name of the person as reference data from a first mobile user terminal for storage, and transmit the identification data of the person corresponding to the name of the person as reference data to a second mobile user terminal for sharing the identification data of the same person corresponding to the name of the same person between the first and second mobile user terminals for the purpose of increasing accuracy and efficiency of the personal identification; and
a reference data controller that allows the server communicator to transmit the identification data of the person corresponding to the name of the same person as reference data, which has been received from the first user terminal, to the second user terminal on the condition that the same person has given a self-introduction both to a user of the first user terminal and a user of the second user terminal to keep privacy of the same person against unknown persons.
